(19) United States
(12) Patent Application Publication
(10) Pub. No.: US 2013/0159180 A1
(43) Pub. Date: Jun. 20, 2013

(54) WALLET BANKING SYSTEM

(71) Applicants: Ashok Jhunjhunwala, Chennai (IN); Burde Suresh Kamath, Chennai (IN)

(72) Inventors: Ashok Jhunjhunwala, Chennai (IN); Burde Suresh Kamath, Chennai (IN)

(73) Assignee: POLARIS SOFTWARE LAB LTD., Chennai (IN)

(21) Appl. No.: 13/697,599

(22) PCT Filed: Sep. 1, 2010
(86) PCT No.: PCT/IN10/00582

§ 371 Date: Feb. 26, 2013

(30) Foreign Application Priority Data
May 10, 2010 (IN) 1309/CHE/2010

(51) Int. Cl. G06Q 20/36

(52) U.S. Cl. CPC G06Q 20/36
USPC 705/41

(57) ABSTRACT

A Wallet Banking System (WBS) for handling large volume transactions is disclosed. This invention relates to banking systems, and more particularly to wallet banking systems. Existing banking systems charge a certain amount on per transaction basis. As a result, the customer will have to pay a considerable amount for every transaction transactions that he makes. The disclosed method creates a wallet account for every core bank account of a customer that requires payments. An amount of money is automatically made available from the customers' core bank account to the customers' wallet account in WBS by using lien facility. The amount made available to the wallet account, there after becomes available for making payments from WBS. WBS will post a consolidated entry at the end of the day into customers' operational account in CBS thus reducing the entries that get posted into the CBS to a minimum.

### FIELD OF INVENTION

This invention relates to banking systems, and more particularly to accessibility of banking systems.

### BACKGROUND OF INVENTION

In recent times, there has been a substantial increase in electronic money transactions for transferring money electronically. Present day banking systems offer a number of services to their customers to transfer money electronically such as mobile banking, Internet banking, Short Message Service (SMS) banking and so on. In case of mobile banking systems, the banks charge the customer for providing banking services. The charges generally apply on per transaction basis. As a result of this, when there are a large number of transactions to be carried out by a customer using such services, the customer will be charged a considerable amount for the transactions performed. There is every possibility that a large number of transactions are performed. In such a case, the amount charged for processing the transactions and providing the details of every transaction to the customer's bank account may be high, as the details have to be provided for each transaction and there is a charge associated with each transaction. Also, it becomes difficult for the banking systems to maintain a ledger for the account of the customer for a large volume of transactions due to the large number of transaction entries to be handled. In addition, present core banking systems employed in large banks need expensive IT infrastructure and the incremental cost to this infrastructure in commensurate with growth in the volume of transactions which also is increasing rapidly. This has resulted in higher transaction costs for banks. Further, with the exponential growth of mobiles and usage of mobile devices for making payments and banking services, it is expected that the number of payments is going to grow exponentially to huge volumes. As a result, there will be more load on the banking systems to handle very high volume transactions. Thus, resulting in higher transaction processing costs for the banks.

Some banking systems have introduced sub-accounting mechanisms wherein a plurality of sub-accounts will be maintained for a customer's existing core bank account. The sub-accounts may be pre-defined for a definite purpose i.e., a customer may categorize an account for paying bills, another account for shopping and so on. However, there is no proper synchronization between the sub-accounts and the corresponding core banking account; as a result, if the balance in the sub-account is not sufficient for performing a transaction there is no support from the core bank account to enable the transaction further by transferring some amount to the sub-account. This means the amount in one sub-account is employed only for the purpose for which the customer has defined that sub-account. Further, there is no means to transfer back the unused money from the sub-accounts to the core banking account when required. Also, transaction details of every sub-account are separately provided to the core banking account. As a result, every transaction entry is charged separately thus adding to the cost to the bank for processing transactions and to the customer.

### SUMMARY

In view of the foregoing, an embodiment herein provides a banking system for handling transactions in a banking environment. The system comprises of a wallet engine for creating a wallet account for a core bank account maintained in the banking environment where the wallet account operates in synchronization with the core bank account, the wallet engine checking if the balance in the wallet account is sufficient for performing a transaction on receiving a request for a transaction from a customer through a mobile transaction interface, a core banking interface for making part of the money from the core bank account available in the wallet account using lien facility in the core bank account, and the core banking interface for sending a consolidated entry of a plurality of transaction performed by the wallet account maintained in wallet journal to the core bank account at a pre-configured time. The banking system is further adapted for making available money to the wallet account through the core banking interface at a time pre-configured by the customer. The banking system is further adapted for making available money to the wallet account through the core banking interface wherein the money is an amount pre-configured by the customer. The banking system is adapted for checking the balance in the wallet account on receiving the request for the transaction wherein the request is received through a mobile device from the mobile transaction interface. The banking system is adapted for sending the consolidated entry to the core bank account through the core banking interface at a pre-configured time wherein the pre-configured time is defined by the bank's policy. The banking system is adapted for requesting the core bank account for making available additional amount through the core banking interface when the balance in the wallet account is not sufficient to make the transaction. The banking system is adapted for informing the customer through the mobile transaction interface when the balance in the wallet account is not sufficient to make the transaction. The banking system is further adapted for obtaining history of transactions performed by the wallet account from the wallet journal. The banking system is adapted for receiving requests to a direct access module for a transaction from portals, delivery channels and branches.

Embodiments further disclose a method for handling transactions in a banking environment. The method comprising of a wallet journal, a core banking interface, a wallet engine, a reports/queries handler, a direct access module and a mobile transaction interface. The method adapted for the wallet engine creating a wallet account for a core bank account maintained in the banking environment where the wallet account operates in synchronization with the core bank account, the wallet engine checking if the balance in the wallet account is sufficient for performing a transaction on receiving a request for a transaction from a customer through mobile transaction interface, a core banking interface for making part of the money from the core bank account available in the wallet account using lien facility in the core bank account and core banking interface sending a consolidated entry of a plurality of transaction performed by the wallet account maintained in queries and reports handler to the core bank account at a pre-configured time. The method makes available money to the wallet account through said core banking interface at a time pre-configured by the customer. The method makes available additional money to the wallet account through said core banking interface depending on an amount pre-configured by the customer. The method checks the balance in the wallet account on receiving the request for the transaction through a mobile device from the mobile transaction interface. The method sends a request to the core bank account for making available additional amount through the core banking interface when the balance in the wallet account is not sufficient to make the transaction. The method informs the customer through the mobile transaction interface when the balance in the wallet account is not sufficient to make the transaction. The method sends said consolidated entry through said core banking interface to the core bank account at a pre-configured time wherein the pre-configured time is defined by the bank's policy. The method further receives history of transactions performed by the wallet account from the wallet journal. The method further receives requests to a direct access module for a transaction from portals, delivery channels and branches.

These and other aspects of the embodiments herein will be better appreciated and understood when considered in conjunction with the following description and the accompanying drawings.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates an architecture of the wallet banking system, according to embodiments as disclosed herein;

FIG. 2 illustrates a wallet bank account, according to embodiments as disclosed herein;

FIG. 3 is a flow chart depicting the method of the wallet account handling transactions, according to embodiments as disclosed herein; and

FIG. 4 is a flow chart depicting a scenario of handling transactions in wallet banking system, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

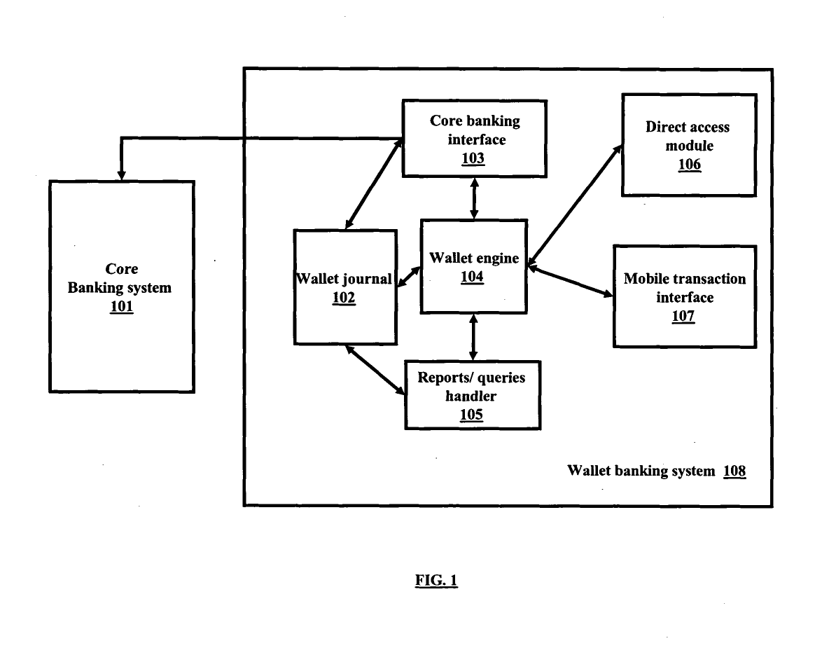

The embodiments herein provide a method and system for handling large volume transactions in banking systems. Referring now to the drawings, and more particularly to FIGS. 1 through 4, where similar reference characters denote corresponding features consistently throughout the figures, there are shown preferred embodiments.

A Wallet Banking System (WBS) for handling transactions is disclosed. The method creates a sub-account, herein after referred to as a wallet account, for the core bank account of a customer that requires large volume payments. The wallet account handles the transactions of a customer, which are done using mobile devices. This system can also process banking transactions originated by banking correspondents for inclusive banking. The core bank accounts of customers will be maintained in the Core Banking System (CBS) and function in sync with the wallet account. A small amount of money is automatically made available from the customers' operational account in CBS to the customers' corresponding wallet account in WBS. The amount available is as per customer's preferences. The amount is made available from the operational account in the CBS by using the lien facility i.e., when a amount is assigned by a customer to a wallet account that corresponding amount in the CBS is marked as a lien.

The amount made available to the wallet account, there after becomes available for making payments from the WBS. Thus, reducing risks of exposure of huge amounts of money to channel risks. The WBS will receive requests for payments and authorize them subject to availability of balance in the wallet account. The WBS will maintain a detailed ledger for each wallet account. The WBS will post a consolidated entry at the end of the day into the customers' operational account in CBS. This process will reduce the number of entries that get posted into the CBS to a minimum The CBS in banks will not have to process a large volume of transactions. Hence, the transaction costs applied to the banks is reduced as a large volume of transaction details may be processed as a single entry.

FIG. 1 illustrates architecture of the wallet banking system, according to embodiments as disclosed herein. The Wallet Banking System (WBS) 108 comprises of a wallet journal 102, a core banking interface 103, wallet engine 104, a report/queries handler 105, a direct access module 106 and a mobile transaction interface 107. The WBS 108 is interfaced with the CBS 101.

The core banking system (CBS) 101 comprises of the operational account of the customer for which the corresponding WBS 108 is maintained. The CBS 101 may maintain different types of accounts such as savings account, current account or the like. The CBS 101 is capable of processing transactions originating from mobile devices for mobile banking. All large value transactions are handled by the CBS 101. An amount necessary for the transactions is made available by the CBS 101 to the WBS 108 by making a lien on the amount made available. In scenarios where there is not enough balance available in the CBS 101 the balance in the WBS 107 may also be made available to the CBS 101. For instance, when there is a check issued by a customer during his regular banking and if the balance in the CBS 101 is not sufficient for processing the transaction, then the amount marked for the wallet account may be also used by the CBS 101 to process the transaction by revoking the amount available in the wallet account.

Wallet journal 102 is a system of records for maintaining the details of every transaction performed by the wallet account 202. The wallet journal maintains a detailed ledger of every transaction that is processed by the wallet account 202. At the end of the day or as per the settings of the bank the wallet journal 102 may post a consolidated entry of the entire transactions made in that particular time period to the CBS 101. Further, the settings may be configured by the bank to post the transactions entry either at the end of the day, week, month or the like.

The core banking interface 103 acts as an interface for the WBS 108. The core banking interface 103 is the point of integration between the WBS 108 and the CBS 101. The core banking interface 103 sends the request for an amount from the customer's CBS 101 to the WBS 108. The core banking interface 103 also posts consolidated transactions of the customer to the CBS 101 and receives requests for processing the transactions from the CBS 101. In addition, the core banking interface 103 processes any queries from the CBS 101 for enquiring balance available in the wallet accounts, enquiring a transaction history of an account in the WBS 108 and so on.

The wallet engine 104 is the central module that provides the necessary functionality required to process transactions that are routed to the WBS 108. For every account in CBS 101 that requires making large volume payments/receipt services, a dummy wallet account is maintained in wallet engine 104. In addition, customer's preferred settings like details on the balance in the wallet account is also maintained in the wallet engine 104. In addition, the wallet engine 104 may maintain the details on transaction history in the wallet journal 102.

The reports/queries handler 105 serves the MIS needs of the banks and customers. The reports/queries handler 105 is responsible for servicing all the reports and queries using the transactions details of the wallet account in the wallet journal. In addition, any queries posted by the customers through his mobile device may be handled by the reports/queries handler 105 and sent to the module that addresses the query. The reports/queries handler 105 can be used directly through a web browser or core banking module through its interface.

The direct access module 106 provides interface to the WBS 108 from different portals, branches, delivery channels and the like in order to perform configuration of the wallet system 108 for the customers and set up bank parameters. Requests originating from any of the portal, branches, and delivery channels through the direct access module 106 may be processed by the WBS 108.

The mobile transaction interface 107 provides integration with the switch enabling channel transactions. All mobile transactions may be routed to the WBS 108 using the mobile transaction interface 107.

The wallet banking system 108 encompasses all the modules within it The WBS 108 maintains a wallet account to handle transactions of a customer. A wallet account is maintained for every account of a customer in the CBS 101 who opts to make payments using the wallet account. As per the preferences of the customer, an amount will be made available to the wallet account from the core bank account of the customer on a lien basis. The amount that is made available to the wallet account becomes available for making payments.

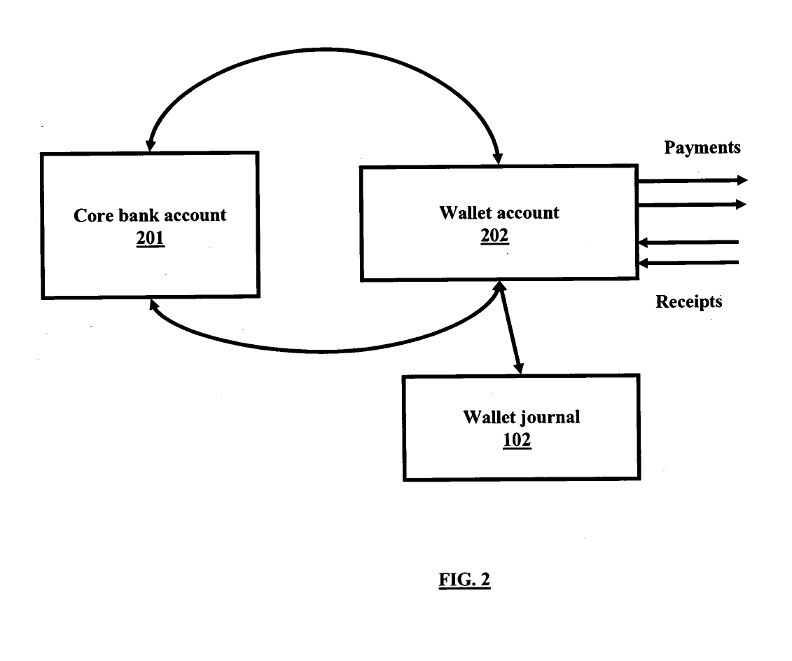

FIG. 2 illustrates a wallet bank account, according to embodiments as disclosed herein. For an account of a customer in the CBS 101 who makes a large number of transactions, a wallet account may be set up in the WBS 108. The bank may provide different options to their customer's to set their preferences and configure the amount of money made available to the WBS 108 accordingly. In an example, the bank may let a customer configure a fixed amount at the start of the day, or may make the configuration of the amount available for a week or the like. The customer may configure his settings using his mobile device by communicating with the WBS 108. In addition, the customer may be provided the option of making addition money available in intermediate intervals by taking his consent in case if the balance in the wallet account is not sufficient for a particular transaction request. In an embodiment, the preferences of the customer may be set on a one time basis or as per his convenience. The amount configured for the WBS 108 becomes available in the wallet account 202 of the customer for making payments. A lien is maintained in the core bank on the amount that is made available to the wallet account 202. In an embodiment, the customer may be provided an option by the bank to choose the account from which he can make his payments. In an example, the bank may provide the option of making payments to registered beneficiaries from the CBS 101 and payments to unregistered beneficiaries from the wallet account 202. In addition, the customer may also configure his settings such that his cheque, demand draft and so on may be processed by the CBS 101.

Further, when the WBS 108 receives a request for any payment to be performed, the WBS 108 may authenticate the details of the customer before processing the transaction. On authentication, a check is made with the wallet account 202 if the balance in the wallet account 202 is sufficient for the transaction. If the balance is sufficient for the transactions, the payment is made. In an embodiment, the details of the payment made may be sent to the wallet journal 102 to maintain a detailed ledger for wallet account transactions. At the end of the day, when all the transactions are completed a consolidated entry of the total transactions made by the customer may be posted to the CBS 101 by the wallet journal 102. In another embodiment, it may also be possible that the bank may have configured the settings such that the details of the transactions may be sent to the CBS 101 at the end of the week, every fortnight and so on. This process will reduce the number of entries that get posted into the CBS 101 to a minimum and reduce the volume of transaction entries to be handled by the CBS 101. The balance in the wallet account 202 will also be made available to the CBS 101 to satisfy any debit/withdrawal transactions that happen in the CBS 101 only if the balance of the operational account by itself is not sufficient for the transaction. The wallet account 202 can also be configured to make available the residual amount in the wallet account 202 to the operational account, whenever required. When consolidated transactions get posted into the CBS 101 the residual amount that was held for the wallet account becomes available for making any payments from the CBS 101, further the lien on the amount is removed. In addition, the CBS 101 may continue to maintain the general ledger/balance sheet of the bank, as the primary accounting system for a bank. In another embodiment, it may also be possible to post other transaction details like payments and receipt made by the banking correspondents, either through direct browser based form entries, through uploads, through interface messages or through a web portal.

In an embodiment, the wallet account 202 may be also employed for receiving any amount from another bank account. The other bank account may be a wallet account, a core banking account and the like. In an example, say a customer A has bought grocery from customer B and customer A would want to payment to another customer B, the payment may be made from the wallet account of customer A to the wallet account of the customer B.

In an embodiment, the bank will use the CBS 101 to maintain a chart of accounts, provide trial balance and balance sheet of a bank and make accruals and interest payments.

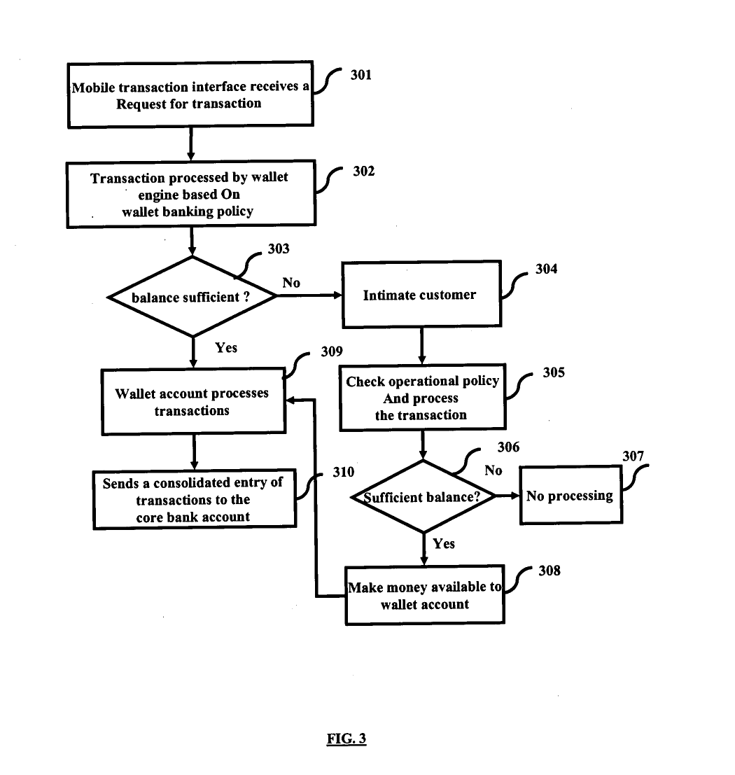

FIG. 3 is a flow chart depicting the method of the wallet account handling transactions, according to embodiments as disclosed herein. A customer who uses a communication device makes a request for a transaction. The communication device may be a mobile device, a laptop, a personal data assistant or the like. Consider the request for transaction is sent from a mobile device. When a request for processing a transaction hits a WBS 108, the transaction request is received (301) by the mobile transaction interface 107. The mobile transaction interface 107 may authenticate the details of the customer for processing the transaction further. The mobile transaction interface may then route (302) the request to the wallet engine 104. The wallet engine 104 may process the transaction based on the customer's preference maintained by the WBS 108. A check is made (303) if the balance in the wallet account 202 is sufficient for the requested transaction. If the balance is sufficient for the transaction, the transaction may be processed further. On the other hand, if the balance in the wallet account 202 is not sufficient for the transaction, intimation may be sent (304) to the customer stating insufficient balance.

Further, the preferences of the customer may be checked (305) to determine if the wallet account 202 of the customer supports to make available any additional amount for making payments from the CBS 101 when the balance in the wallet account 202 is not sufficient. In addition, the operation policy of the bank may be checked to determine if the bank supports additional money by marking lien on the additional money from the CBS 101 to the wallet account 202 at intermediate intervals on request from the customer. A check may be then made (306) to determine if the balance in the CBS 101 is sufficient to make available the required amount of money. If the balance is not sufficient to make any amount available to the wallet account 202 the transaction may not be processed further and the customer may be intimated (307) that his request for payment failed. In case, the balance in the CBS 101 is sufficient to make the amount available, the required amount may be made available (308) to the wallet account 202 of the customer. Further, the flow may go to step 309, where the wallet account 202 processes (309) the transaction and makes the payment. The details of the transaction may be maintained by the wallet journal 102. Later, a consolidated entry of the transaction details may be posted (310) to the CBS 101 as per the settings of the bank. In an embodiment, the bank may have configured to post the transactions details at the end of the day, week, and month and so on. This minimizes the load on the bank for processing the volume of transactions as a single consolidated transaction is posted for all the transactions. The various actions in method 300 may be performed in the order presented, in a different order or simultaneously. Further, in some embodiments, some actions listed in FIG. 3 may be omitted.

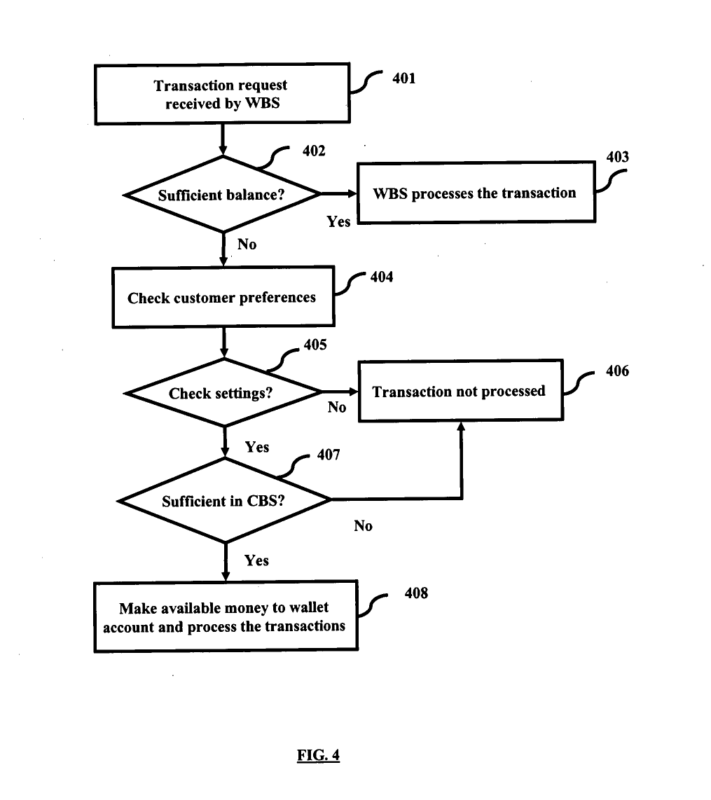

FIG. 4 is a flow chart depicting a scenario of handling transactions in wallet banking system, according to embodiments as disclosed herein. The scenario considered is that of a customer placing a request for a large value transaction to the WBS 108. A transaction request is received (401) by the WBS 108 for the payment. The WBS 108 on receiving the request makes (402) a check if the balance in the wallet account 202 of the customer is sufficient for the transaction. If the balance in the wallet account 202 is sufficient for processing the transaction, then the WBS 108 shall process (403) the transaction and make the payment. On the other hand, if the balance in the wallet account 202 is not sufficient for the transaction, the customer may be intimated. A check is made (404) with the preferences set by the customer. During this process it is determined (405) if the customer has set his account to support any additional money to be made available to the wallet account 202 when requested by the WBS 108 and if the bank's operational policy supports the same. In case, if the bank's policy does not support to make any amount available at intermediate intervals the customer may be informed and the transaction may not be processed (406) any further. If the policy supports any additional amount to be made available, a check is made (407) again to determine if the balance in the CBS 101 is sufficient to make the amount available. If the balance is not sufficient, the process may move to step 406. If the balance is sufficient, the requested money may be made available (408) to the wallet account 202 from the core bank account. A lien may be marked on the core bank account for the additional amount made available to the wallet account 202. The payment is then made from the wallet account 202 and the details of the transaction may be sent to the wallet journal 102. The WBS 108 may later send a consolidated entry of the transaction to the CBS 101 as per the settings configured by the bank. The various actions in method 400 may be performed in the order presented, in a different order or simultaneously. Further, in some embodiments, some actions listed in FIG. 4 may be omitted.

In an embodiment, the customer may be provided access to the direct access module 106. By providing such an access the customer may be able to interact with the direct access module 106 over his mobile device in order to make the required transactions and manage his wallet account over the mobile device.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

The embodiment disclosed herein describes a method for handling large volume transactions by banking systems by providing a wallet account to handle such large volume transactions. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with several software modules being executed on at least one hardware device. The hardware device can be any kind of portable device that can be programmed. The method embodiments described herein could be implemented partly in hardware and partly in software.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A banking system for handling transactions in a banking environment, said system comprising of:
a wallet engine for creating a wallet account for a core bank account maintained in said banking environment where said wallet account operates in synchronization with said core bank account;
said wallet engine checking if the balance in said wallet account is sufficient for performing a transaction on receiving a request for a transaction from a customer through a mobile transaction interface; and
a core banking interface for making part of the money from said core bank account available in said wallet account using lien facility in said core bank account;
said core banking interface for sending a consolidated entry of a plurality of transaction performed by said wallet account maintained in wallet journal to said core bank account at a pre-configured time.

2. The banking system as in claim 1, wherein said system is further adapted for making available money to said wallet account through said core banking interface at a time pre-configured by said customer.

3. The banking system as in claim 1, wherein said system is further adapted for making available money to said wallet account through said core banking interface wherein said money is an amount pre-configured by said customer.

4. The banking system as in claim 1, wherein said system is adapted for checking said balance in said wallet account on receiving said request for said transaction wherein said request is received through a mobile device from a mobile transaction interface.

5. The banking system as in claim 1, wherein said system is adapted for sending said consolidated entry to said core bank account through said core banking interface at a pre-configured time wherein said pre-configured time is defined by said bank's policy.

6. The banking system as in claim 1, wherein said system is further adapted for sending a request for making money available to said wallet account from said core bank account through said core banking interface when said balance in said wallet account is not sufficient to make said transaction.

7. The banking system as in claim 1, wherein said system is further adapted for informing said customer through said mobile transaction interface when said balance in said wallet account is not sufficient to make said transaction.

8. The banking system as in claim 1, wherein said system is further adapted for obtaining history of transactions performed by said wallet account from said wallet journal.

9. The banking system as in claim 1, wherein said system is further adapted for receiving requests to a direct access module for a transaction from portals, delivery channels or branches.

10. The banking system as in claim 1, wherein said system is further adapted for receiving money from one of a bank account or a second wallet account.

11. A method for handling transactions in a banking environment, said method using a system comprising of a wallet journal, a core banking interface, a wallet engine, a reports/queries handler, a direct access module and a mobile transaction interface, further said method comprising:
said wallet engine creating a wallet account for a core bank account maintained in said banking environment where said wallet account operates in synchronization with said core bank account;
said wallet engine checking if the balance in said wallet account is sufficient for performing a transaction on receiving a request for a transaction from a customer through said mobile transaction interface;
said core banking interface for making part of the money from said core bank account available in said wallet account using lien facility in said core bank account; and
said core banking interface for sending a consolidated entry of a plurality of transactions performed by said wallet account maintained in a wallet journal to said core bank account at a pre-configured time.

12. The method as in claim 11, wherein said method makes available money to said wallet account through said core banking interface at a time pre-configured by said customer.

13. The method as in claim 11, wherein said method makes available money to said wallet account through said core banking interface depending on an amount pre-configured by said customer.

14. The method as in claim 11, wherein said method checks said balance in said wallet account on receiving said request for said transaction through a mobile device from said mobile transaction interface.

15. The method as in claim 11, wherein said method sends a request for making available additional amount to said wallet account from core bank account through said core banking interface when said balance in said wallet account is not sufficient to make said transaction.

16. The method as in claim 11, wherein said method informs said customer through said mobile transaction interface when said balance in said wallet account is not sufficient to make said transaction.

17. The method as in claim 11, wherein said method sends said consolidated entry to said core bank account through said core banking interface at a pre-configured time wherein said pre-configured time is defined by said bank.

18. The method as in claim 11, wherein said method further receives history of transactions performed by said wallet account from said wallet journal.

19. The method as in claim 11, wherein said method further receives requests to said direct access module for a transaction from portals, delivery channels or branches.

20. The method as in claim 11, wherein said method further receives money from one of a bank account or a second wallet account.
